(19) United States
(12) Patent Application Publication
(10) Pub. No.: US 2004/0148202 A1
(43) Pub. Date: Jul. 29, 2004

(54) Life Insurance Continuation Plan

(76) Inventors: Michael G. Siefe, Santa Barbara, CA (US); Don R. Kuhn, Fallbrook, CA (US)

Correspondence Address: GREENBERG & LIEBERMAN, 314 PHILADELPHIA AVE., TAKOMA PARK, MD, 20912, US

(21) Appl. No.: 10/604,752

(22) Filed: Aug. 14, 2003

Related U.S. Application Data
(60) Provisional application No. 60/442,503, filed on Jan. 27, 2003.

(51) Int. Cl. G06F 17/60

(52) U.S. Cl. 705/4

(57) ABSTRACT

An insurance method wherein an insured and/or his current insurance policy is analyzed and the policy owner is offered a new insurance contract for consideration and/or the receipt of benefits from the insured's old insurance policy. Premiums are readjusted for the insured so that the new insurance policy is more favorable than the old insurance policy. Health and age, amongst other factors, play a role in the new required premium and structure. When the insured dies, the benefit from the old insurance policy is transferred to the new owner who then pays out the benefit specified in the new policy.

### CROSS REFERENCE TO RELATED APPLICATIONS

Priority is hereby claimed to application Ser. No. 60/442,503 in the names of Michael G. Siefe and Don Kuhn filed on Jan. 27, 2003 entitled Life insurance continuation plan.

### BACKGROUND OF INVENTION

The present invention is a business method for life insurance. Specifically, the present invention is a business method wherein life insurance is purchased or maintained at a lower cost than traditionally available because premiums are calculated based upon an individual's current health. Alternatively, the present invention provides guarantees a client does not currently have.

Life insurance is oftentimes thought of as a necessary evil. Individuals recognize the benefits of life insurance, although the terms under which life insurance is traditionally provided dissuade many individuals from ever purchasing life insurance. Worse still, many individuals maintain life insurance in the younger years of their life, foregoing important life insurance coverage in the latter years of their life. In some instances, a large amount of money is paid over an individual's lifetime for life insurance premiums, and once the life insurance term expires later in life, there is little if any way for the individual to recoup any of the money paid as premiums. Thus, there are many factors that make life insurance a rather uninviting prospect for individuals.

In short, the problem is that millions of people, even if they have life insurance for some period of time, will drop life insurance coverage someday. Some will drop coverage because they are tired of paying premiums or the premiums have become too high. Life insurance costs traditionally rise overtime, no matter which insurance product an individual maintains. When a person buys life insurance, premium levels are often calculated with the concept of a person living to the maturity age of the life insurance contract. Oftentimes this age is 100. Sometimes it is earlier than 100, and often times it is past 100. Keeping life insurance through the maturity age of the life insurance contract can be very expensive. Clearly term insurance costs go up significantly at advanced ages (if it can even be continued). Universal life (UL) policies, also known as flexible premium adjustable life policies, have flexible premiums; however, the underlying cost factors go up significantly at older ages. The cost factors on most interest sensitive whole life policies go up as people age. When properly analyzed (including opportunity cost of the cash values), traditional whole life policies and variable life policies have increasing costs as people age.

Moreover, with interest rates credited in insurance policies and insurance dividend rates coming down (and other factors including falling investment yield on variable life policies, possible increases in mortality costs, increases in expenses charged in life insurance contracts, etc.), owners of insurance policies will have to pay premiums longer than they had expected on many cash value life insurance policies. Alternatively, they may have to pay higher premiums than they had originally anticipated paying on some types of policies. Higher premiums are always a negative to the insured.

Some people will drop life insurance coverage because it is just too confusing to maintain or viewed as a waste of money. For example, UL policies, one of the more popular types of life insurance, can be written with a level death benefit or increasing death benefit. In reality, most UL policies are written with a level death benefit because of cost. If a person dies with a level death benefit, whatever cash values are in the policy are essentially wasted. For example if a decedent has an insurance policy with a $1,000,000 death benefit and a $700,000 cash value, the policy still only pays $1,000,000 to the beneficiary. In contrast, if the same policy has $10,000 in cash value, it would still pay $1,000,000 to the beneficiary. Importantly, any extra premiums—the premiums are flexible within limits—paid to build up the higher $700,000 cash value are wasted by the policy owner in this example. If the policy owner maintains a cash value of only $10,000 in the policy, the policy owner is only saving money in the short run; the policy owner runs the risk of the policy being under funded and negatively amortizing the cash values of the life insurance policy. As the policy values negatively amortize, the policy owner has to eventually increase premium payments, reduce the life insurance face amount, or risk not having coverage on a long term basis.

Restated, the problem is that many individuals, even if they have life insurance, waste money in maintaining the policy or will cancel life insurance prematurely. In essence, as alluded to in the previous paragraph, the policy owner needs to monitor the life insurance policy carefully. The policy owner would greatly benefit if the policy owner's death could be accurately predicted. Knowing that death would occur soon, the policy owner could pay minimal premiums; however, knowing that death would occur well into the future, more premiums would be necessary to offset the much higher costs of the life insurance at older ages, so the policy owner would plan accordingly. If the policy owner pays minimal premiums and the policy owner lives longer than expected, the insurance program is jeopardized. Thus, many people overpay their life insurance premiums relative to their current health and life expectancy in order to avoid under-funding problems. This necessary evil is less than desirable.

When premiums become too high, policy holders look to derive some profit from a life insurance policy before abandoning it. Presently, there is a market for viatical and senior settlements. People who no longer need or want their life insurance can sell their existing policies—often at a premium; exceeding their cash surrender values—to investors, groups of investors, limited partnerships, etc. The sale of these policies are based upon many factors such as the insured's age, health, life expectancy, and quality/competitiveness of the existing life insurance coverage and the amount of the cash value in the contract (AHLQC). Many people, however, are uncomfortable about the idea of having investors profiting on their death. Some are afraid that they will be killed so that investors will receive their investment returns. Consequently, there are many reasons that the viatical senior settlements are not used on many cases that could otherwise qualify.

The AHLQC factors are evaluated in total as opposed to individually. For instance, each one is evaluated, but it is the aggregate effect of the factors together, which determine the value of an existing policy to those investors.

Viatical and Life settlements evaluate the AHLQC factors in order to determine a present value of an existing policy. The better a policy, the older a client, the shorter the life expectancy, etc. the more an investor is willing to pay. The bottom line, is that investors buy a policy with the expectation that a death benefit will be paid to them within a certain period of time and for a certain cost of maintenance (of the existing policy). The insured/owner is paid cash today for the policy they bought years ago. The investors pay today with the expectation of a death benefit payable to them in the future. That future date is based primarily on the insured's current age, health, life expectancy. The cost of maintaining the existing policy is based on how long the investors will have to pay premiums (ie. that future date mentioned above) and how competitive that policy is (ie. how low/high the costs on that policy are). So, the investors will estimate the cost of the current policy until the client is expected to die, the present value of the death benefit at that date (rate used for that calculation is the desired return on investment), and pay the client the difference.

One current practice is for agents to settle a policy and then use that money to buy a new policy that creates two sales for the agent. This slick replacement package might be ethically challenged when one considers that the new policy being issued is based on the current underwriting practice of insurance companies where less healthy insureds pay more. In fact, some advisors may view such a strategy as a neatly packaged program to “churn” existing insurance policies to earn extra commissions. So, while the settlement pays more for someone with impaired health, the new insurance policy costs more. Clients will sometimes do this in order to get a new product that has better guarantees. With existing insurance policies, clients will pay a premium to carry the policy to age 100; this means they are often overpaying for their insurance because most people will not live to age 100. Unlike the present invention, the just described second policy is often calculated to age 100. It is also important to keep in mind that the newly calculated premium will be higher for those with less than average health which compounds the overpayment even more. Unlike the present invention, the just described second policy is often calculated with premiums which are higher than the just described policy which was surrendered.

People, on average, would prefer that any value on the AHLQC factors aggregate to benefit their heirs rather than investors. Additionally, in some cases, money from life insurance is oftentimes not needed in retirement. For these reasons, viatical settlements and senior settlements do not well address the market place. Thus, there is a need for a method for providing insurance at reduced rates based upon health factors, such that the insured can save money while alive without losing existing benefits. While there are a variety of insurance products available, as detailed in the following paragraphs, none meet the present need because of their deficiencies.

In the past, one insurance company offered clients new policies without the insured having to be healthy to qualify. In order to cover itself against the increased risk, the insurance company required that the insured assign the old insurance contract to the new insurance company. The new insurance company would keep the old insurance contract in order to mitigate its risk of taking on an unhealthy insured. Unlike the present invention, the new policy this company offered was not tailored to the AHLQC factors. Unlike the present invention, the new policy would not have better terms if the client had shortened life expectancy. Unlike the present invention, no credit was given in the new policy for diminished life expectancy only a credit for existing cash values. Unlike the present invention, the new insurance policies were similar in design to the company's normal product line. For example, a 65 year old healthy, non smoker would be faced with the same premium scenario as another 65 year old unhealthy, non smoker. Thus, unlike the present invention, the unhealthy person would end up with the same insurance package as the healthy person.

Also, in the past, the insurance industry has produced tax-free exchanges, called 1035 exchanges, between insurance policies and annuity policies. When one does a 1035 exchange, the old policy is assigned to the new company. The new company then surrenders the old contract and puts the client's cash values into their new life insurance or annuity contracts' account. Unlike the present invention, 1035 exchanges do not keep the old life insurance contract in force., Rather, the old life insurance contract is surrendered.

Additionally, presently, an insured individual could monitor some types of life insurance, and completely on that insured's own intuition and belief, change the amount of premiums that that insured pays to try to approximate that insured's own life expectancy. A major problem for the insured or owner, in such case, is that there are dire consequences for under or over estimating life expectancy. Unlike the present invention, an insured or owner can severely suffer financially because the law of large numbers with millions of insured individuals will not apply as a cushion in case under or over estimating life expectancy occurs.

Therefore, a need has been established for a life insurance continuation plan that would allow an insurance policy owner to take advantage of the fact that the insured might not live to the maturity age of the contract or might have diminished life expectancy. There is a further need for policy owners to benefit from optimizing their cash values in some types of life insurance contracts. Finally, there is a need for people to be able to keep existing life insurance at the same or lower premiums without the concern of losing their life insurance.

### SUMMARY OF INVENTION

A system wherein life insurance can be purchased or maintained for a lower cost than present outlays is the solution to the aforementioned problems. The present invention enables improved guarantees relative to a policy owner's present life insurance policy as well. The present invention provides, in most cases, coverage based upon AHLQC factors. In most cases, the lower the client's life expectancy or the worse the client's health, the better the deal (cheaper premiums or better guarantees) that the client can be offered by a new insurance company or through other embodiments of this concept.

The present invention, in its simplest form, has an insurance company. underwrite a new life insurance policy on an insured. The present invention should not be limited to insurance company use. For instance, any individual or entity could use the AHLQC factors to determine the cost over time for an existing policy. Then, that entity could provide a guarantee to the insured/owner (for a cost) that if the insured/owner paid the newly calculated premium (ie. cost over time), the policy would stay in force. If there were a miscalculation on the part of this entity, it would have to cover the increased costs. Essentially, another embodiment of the present invention is policy management for a fee.

The underwriting is unique because it essentially rewards through lower premium payments, better guarantees, shorter time for premiums and/or other sweeteners—older age, poor health, and/or diminished life expectancy and quality of existing insurance (ALHQC). In short, most people will not live to age 100 or beyond. Most premiums today are calculated based on a time horizon which exceeds most people's true life expectancy. Thus, most clients overpay for their insurance coverage. By more accurately evaluating how long a policy needs to stay in force, and how much it will cost over that period of time, a more appropriate premium can be calculated. The AHLQC factors are used to determine cost and time horizon so client premiums can be more appropriately calculated.

### BRIEF DESCRIPTION OF DRAWINGS

FIG. 1 shows a classic requital scenario.

FIG. 2 shows some possible alternatives to the hypothetical premium of $30,000 annually.

FIG. 3 shows some possible alternatives to the plan design of the new life insurance policy that is part of the present invention.

FIG. 4 shows that in some cases the death benefit could be dropped to a lower level on the new policy.

### DETAILED DESCRIPTION

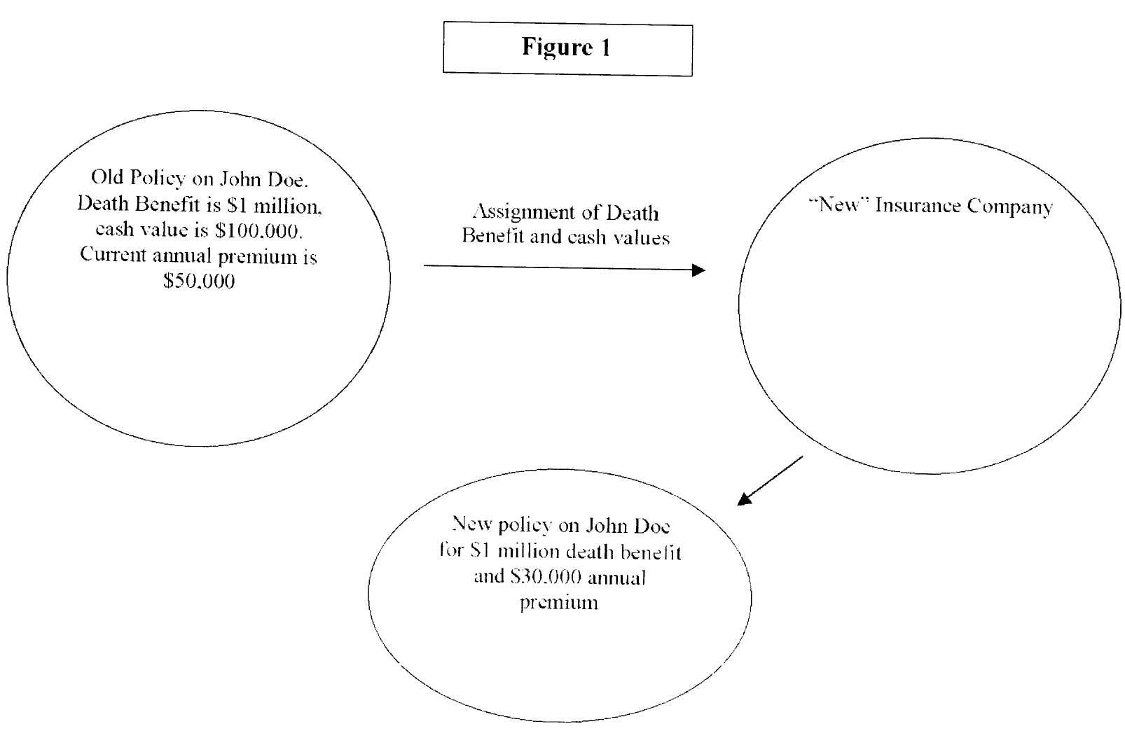

The simplest way to understand the present invention is via the flow chart as represented in FIG. 1. It is essentially simple application of the business method represented in the present invention.

The given information is that John Doe has a universal life policy with a $1,000,000 face amount from ABC insurance company. He has a cash value in his policy of $100,000. He is currently paying premiums of $50,000 annually. He could pay less than $50,000 annually but runs the risk of eventually prohibitive premiums if he lives too long.

To implement the present invention, XYZ insurance company analyzes John Doe's health and finds out that his health is somewhat diminished (this concept may still work if his health is not diminished but the cost/benefit won't be as-good). While we anticipate the greatest client benefits for those whose newly calculated life expectancy is substantially reduced, there are instances where an average client would like the guarantees offered by the present invention. Plus, since most policies will request payments based on carrying a policy to age 100 (or maturity), this program will base that cost over a shorter period of time because even the average person will not live to age 100. Also, see the following paragraph discussing John Doe without significant AHLQC factors. XYZ insurance company then offers John Doe a $1,000,000 policy with a $30,000 guaranteed premium if he will assign (very similar to a 1035 exchange and a 1035 exchange might accomplish this) all rights in his current insurance policy such as ownership, cash value, death benefit, etc. to XYZ insurance company.

Once John Doe has accepted XYZ insurance company's offer for the new policy, XYZ insurance company puts John Doe's current life insurance policy in its portfolio to mitigate XYZ insurance company's risk in case John Doe dies in the near future. Thus, if John Doe dies in the near future, the policy from ABC insurance company will a pay death benefit to XYZ insurance company. In turn, XYZ insurance company then will pay money to John Doe's beneficiary under the terms of the new policy between John Doe and XYZ insurance company. While the present invention anticipates XYZ holding ABC policy until Doe's death, there may be situations where it is beneficial for XYZ to not hold ABC policy until Doe's death. For example, the insured's health suddenly improves so that XYZ determines that ABC policy does not need to be maintained.

As a footnote to the example provided in FIG. 1, assume that John Doe does not have significant AHLQC factors to justify XYZ insurance company offering him lower premiums. Specifically, John Doe cannot benefit from his AHLQC factors. In such case, the present invention is still advantageous because it offers a guaranteed premium since the present invention anticipates regular use of the guaranteed concept; still, the full guarantee is not a requirement as a carrier or entity could offer modified guarantees (i.e. guaranteed for a period of time and then premium could change after that). John Doe is a policy owner that has a contract with ABC insurance company, but his contract is without significant premium guarantees. With the present invention, John Doe can get premium guarantees without paying gigantic commissions to buy a new conventional life insurance policy. The guarantees could be for a one-time premium payment, no further premiums, five-year premium payments, etc. The guarantees could mean guaranteed increasing, decreasing, or level premiums. The premiums could even be indexed to factors. For instance, premiums could start at a certain amount and increase over time. The increase could be based on LIBOR, inflation, or some other index of the company's choosing (think of this like an annual renewable term where the cost goes up each year in a predictable manner, but based on the index a carrier chooses instead of mortality). Another variation a carrier could choose would be to guarantee the premium until life expectancy and then increase it each year after that based on mortality or some other index of the carrier's choosing. Alternatively, a premium could start high and decrease over time; might be attractive for those clients who anticipate lower cash flow in the future (i.e. someone who will retire in the future). The bottom line is that premium schedules can be almost infinite depending on how the client wishes to pay.

In the short run, XYZ insurance company could pay nothing to keep the ABC insurance company's policy in force because ABC insurance company's policy's cash value would keep it in force by itself for several years. The existing cash values could act as a fund for covering the costs associated with the existing policy. If the carrier chose to, it could have the current policy costs taken out of policy cash values until cash value goes to zero. When cash value goes to zero, the new carrier would then have to start paying premiums into the policy so it would stay in force until the client died. Consequently, if John Doe dies in the near future, implementation of the present invention is profitable for XYZ insurance company. Specifically, XYZ insurance company has taken in $30,000 as a premium from John Doe, but technically paid out nothing whatsoever because the $1,000,000 death benefit paid to John Doe's beneficiary under terms of the XYZ policy is equal to the $1,000,000 collected by XYZ from the ABC insurance company.

If, however, John Doe lives a long life, XYZ insurance company will lose money since it will keep paying premiums on ABC insurance company's policy to maintain that policy in XYZ insurance company's portfolio. The premiums for the ABC insurance company policy will continue to increase as John Doe ages, and according to the present invention, once the cash value of the ABC insurance company policy is fully depleted, XYZ insurance company will have no choice but to pay premiums to ABC insurance company to ensure the ABC insurance policy does not lapse. Thus, part of the present invention provides for a proper analysis of an existing insurance policy so that pricing for the insured is commensurate with life expectancy. Insurance companies have huge amounts of data which allow them to be statistically certain of the date of death when their samples are large enough. The way a carrier uses this invention, and averts losing money, is by using this program with a large number of clients. Thus, over large numbers of lives, it will be almost certain of ensuring profitability.

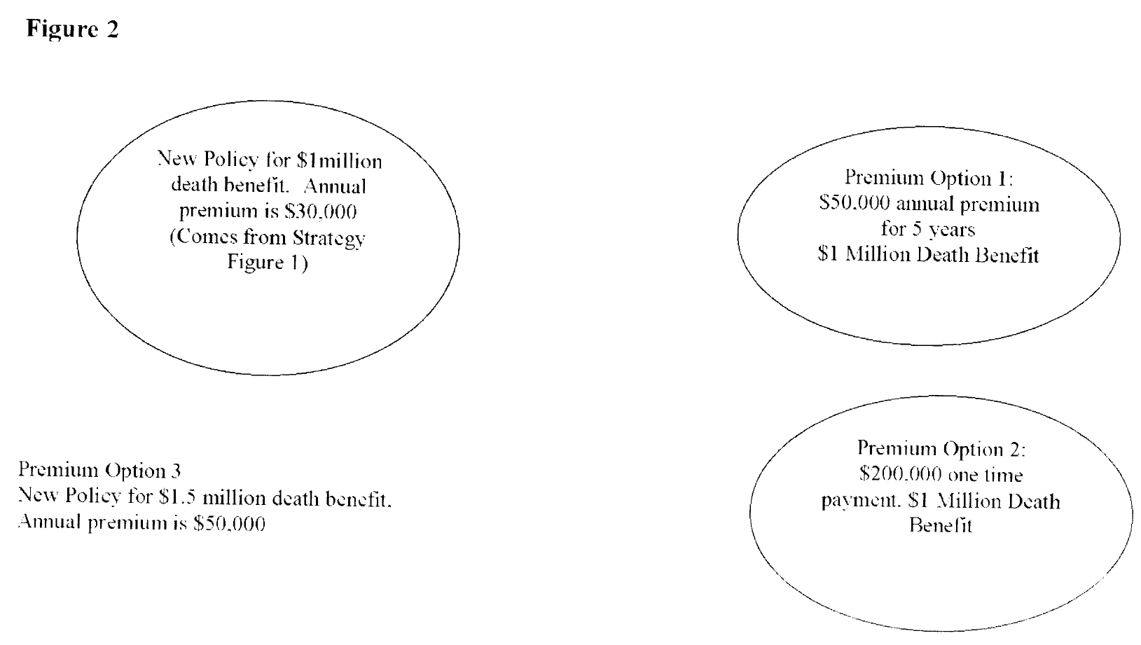

FIG. 2 shows some possible alternatives to the hypothetical premium of $30,000 annually. Virtually any other premium configuration could be used that would satisfy XYZ insurance company's desire for profitability, as well as the policy owner's desires as to how the policy owner desires to pay premiums. In alternative 1, the policy owner could pay $50,000 annually for 5 years and then pay no further premiums. Alternative 2 shows a one-time premium of $200,000 and no further premiums. This invention envisions being able to offer various schedules of premium which are equal on a present value basis, but can be funded over various periods of time. Just like mortgages can come in 15 or 30 year notes, this program could provide for various funding levels and/or time frames. For instance, XYZ uses AHLQC factors to calculate when ABC policy will pay out the death benefit and how much it will cost until then. Once this information is known, XYZ can calculate various times frames and premiums required to provide them desired return on investment.

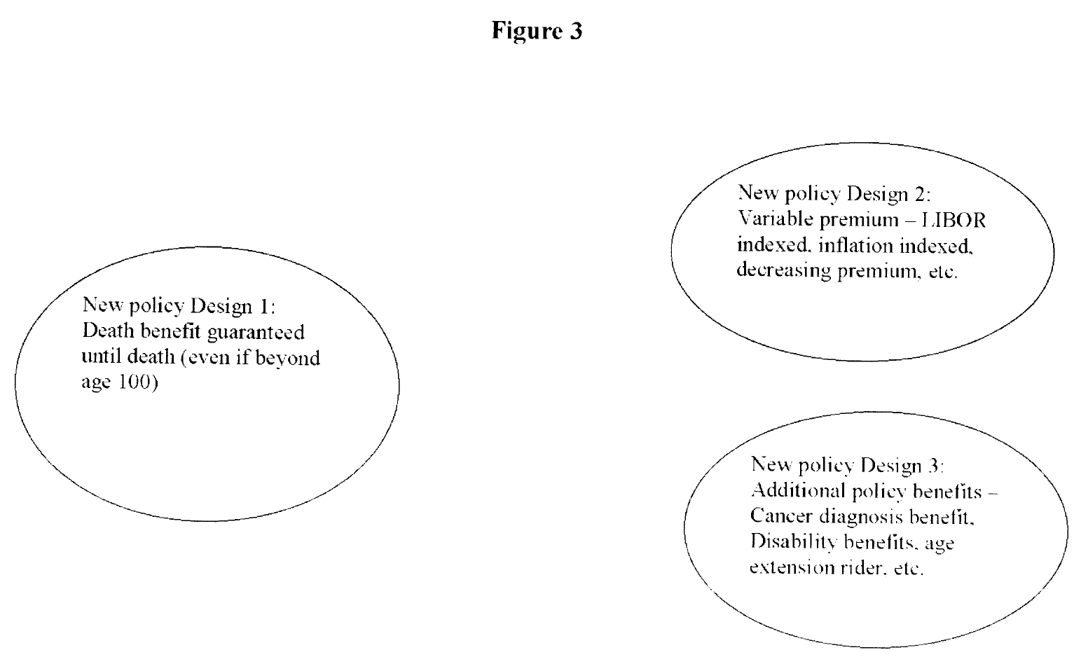

FIG. 3 shows some possible alternatives to the plan design of the new life insurance policy that is part of the present invention. Virtually any benefit or rider can be added to the new policy that XYZ insurance company offers; that benefit or rider is not necessarily a feature from the old policy. This is only one example of how the new policy could be improved via the use of riders. Virtually any rider or benefit could be added to the new policy just as if it were a normal insurance transaction; often, the additional cost for these riders or benefits could be more than covered by the cost savings received under the use of present invention. Alternative Design 1 allows the death benefit to continue beyond age 100 until the client actually dies. This is preferable because the policy owner could currently have insurance run out at age 100 under many current life insurance configurations. Also, many current plan configurations could cause taxable gain at age 100 if there is a gain in cash value relative to premiums put into the life insurance policy. This problem would be solved because the present invention provides for a new contract to continue insurance to a really old age. Newer policies offer this “maturity extension rider” while many older policies do not. Policies which mature are required to pay the cash value out to the owner of the policy. To the extent this cash value exceeds the premiums paid, the client will have taxable gain. Current invention could provide a policy which has no maturity and thus no taxation.

One current insurance plan configuration, which could cause taxable gain, is the lifetime use of policy cash values through loans and withdrawals. Since life insurance is a FIFO (first in first out) contract, withdrawals come out tax free first (as a return of basis). After the withdrawal of their basis, many policy owners take loans out against the policy cash values (again a tax free distribution). When the client dies, the loans are paid back from the death benefit proceeds. If the policy lapses prior to death, and the loans have not been paid back, those un-repaid loans will be treated as taxable income. Using AHLQC, the present invention could provide the opportunity to both maximize that lifetime income, and guarantee the policy does not lapse prior to death. With most clients, a calculation is made to determine how much a client can take from the policy on a regular basis such that there is at least $1 in the policy at maturity. In fact, many agents will calculate how much can be taken out so the policy has cash value at maturity. Present invention could use AHLQC factors to determine how much could be taken out and have the policy stay in force until life expectancy. For instance, a client would normally have the company software calculate annual withdrawals and loans the policy could provide from age 65 to age 90 but still stay in force until age 100; the policy must have cash values sufficient to cover policy costs from age 90 to age 100. With the current invention, a carrier could use the company software to calculate the maximum distributions obtainable so the policy only had to stay in force until life expectancy; if life expectancy is age 90, XYZ does not need any money in the policy to carry for age 90 to age 100. Again, XYZ would need enough clients doing this so that they would be statistically certain of life expectancy.

It is expected that most policy owner' s implementing the present invention would want a guaranteed premium from, per the aforementioned example, XYZ life insurance company. Many policy owners would be exchanging old policies that did not have a very good guarantee for the policy described in the present invention that would have a significantly better guarantee. However, some policy owners might want a policy that offers a lower, but not entirely guaranteed premium. Alternatively, they may want a payment schedule where premiums increase over time or decrease over time (on a guaranteed or non guaranteed basis). This would be possible in the present invention, as aforementioned, because it presents a new policy that can be retailored as necessary.

Alternative Design 2 indicates that a premium might also be indexed to some other factor such as LIBOR rates, CPI, Cost of Reinsurance, etc. Tying the client premium to CPI would allow the client and carrier to negate the effects of inflation or loss of purchasing power. The client would particularly appreciate premiums tied to CPI because it would afford them a manageable premium that increased as their purchasing power increased. The carrier might appreciate the revenue generated from these sales would keep pace with inflation. An alternative design could be to provide a premium to the client which would change based on the experience a carrier has with its costs. For instance, a reinsurance arrangement between XYZ and its reinsurer may improve (i.e. costs are lower than anticipated). If the reinsurer reduces it's cost to XYZ, XYZ could pass that along to the client (ie. Lower premiums or dividends). In short, a variety of mechanisms could be used to give a client lower (but variable) premiums.

Alternative Design 3 shows that riders could be put on the plan that did not exist in earlier coverage. In this example, a sweetener could be added such as providing a $50,000 payment to the policy owner if the insured is ever diagnosed with cancer. Riders could be added that would provide disability income, accidental death enhancement of death benefit, etc. Because XYZ company has evaluated AHLQC factors, it should have a unique perspective on the client's current situation. What this means is that because they expect payment from ABC at a relatively certain time, they would have a future payment which could be used as reimbursement for an event that may have to be paid prior to life expectancy. The rider benefit should be the present value of the death benefit minus the costs, minus profit expectation. Again, the difference between present invention and normally issued policies is that this invention provides XYZ with a death benefit whereas current practice is just to apply ABC surrender values to XYZ policy; presumably, the death benefit payable at a future date is worth more than the surrender value today.

Alternative Design 4 contemplates that a company offers a contract issued on an individual that provides if he or she lives past a certain time period he or she would receive a lump sum payment or stream of payments from the contract issuer. The contract holder would get little or nothing if he/she died before the specified date in the contract.

As an example, if an individual is afraid he or she will live too long and that the premiums on his or her life insurance would become exorbitant, he or she could buy this contract (based on AHL factors) for a premium of $20,000 per year for 10 years (or some other period of time the parties agreed to) and get a contract that would pay the $500,000 (for example) at the end of 10 years—only if the individual was still living. That money (the $500,000 in this example) might then be used to pay future premiums on their existing life insurance. AHLfactors would tend to reduce the premium relative to the payout ($500,000 in this example). This contract would be completely independent of the life insurance policy that the policy owner wanted to keep. But, this contract allows the client to pay lower premiums on his or her “old” contract knowing that if he or she “lives too long” he or she will have a large pot of money paid to him or her at a specified future date.

Alternative Design 5 provides as follows: An individual or couple is afraid that they will outlive their retirement savings if they live too long. At age 55 they come up with a financial plan that will allow them to live comfortably until age 90 at which time they will be broke and will have outlived their assets. They pay a premium of say $1,000 per year for the next 35 years. If they live beyond age 90, they are given a payment of $200,000. Of course the payment could also be a series of payments similar to various settlement options currently offered by financial services firms (again, the payment is based on AHL factors).

In short, by evaluating or calculating what the life expectancy is, a carrier could issue a contract (for a premium) that pays a lump sum to the purchaser at some agreed upon future date. Premiums would be based on the relationship between that future date and the life expectancy. For instance, the shorter the life expectancy and the longer the contract period, the lower the premium will be. On the other hand, the longer the life expectancy and the shorter the contract period, the higher the premium will be. We propose this contract is a new and unique concept directly related to the life insurance continuation plan because it takes into account life expectancy and time horizon in calculating client outlay.

Another unique aspect of the present invention is that it helps insurance companies on their reserve requirements. Traditionally, when a life insurance company offers a life insurance policy, the life insurance company profits if the insured lives long enough to pay more premiums than the benefit it pays out. Conversely, the life insurance company loses money if the insured dies quickly because a benefit is paid which is oftentimes greater than the premiums paid, even assuming the premiums were invested. Significantly, the present invention turns such profitability notions on their head the rules governing profit and loss are reversed. With the present invention, if the insured dies quickly, the company profits. On the other hand, if the insured lives too long the present invention would not be profitable for the insurance company. Consequently, the present invention balances the existing risk in an insurance company's portfolio, since it is assumed that the insurance company will already have, and will continue to issue, traditional insurance policies while simultaneously implementing the present invention.

Furthermore, the present invention reduces the need for reinsurance, and potentially, reserve requirements. Reinsurance is where a carrier “partners” with another entity that guarantees to share the risk with the insurance company. For instance, a carrier may offer a $1 million policy to a client but have this other entity (i.e. reinsurer) agree to pay part of that $1 million. Carriers do this in order to share the risk they have to pay out large claims on unfavorable terms. In short, reinsurance is insurance for insurance companies. Because the regulatory bodies recognize insurance companies will have to pay claims but desire to maximize profit, the regulatory bodies have established reserve requirements. Reserves are held by carriers in conservatively invested accounts (read, low yield) so as to have a reasonable expectation there is enough money to pay claims. The amount of reserves is calculated using statistical analysis of the carrier policies. Based on current industry practice, regulators require more money be held in reserves for policies which cover insureds with short life expectancies. So, the shorter lifespan someone is expected to have, the more a carrier must hold in reserves. The present invention almost perfectly matches a liability with an asset (almost dollar for dollar). This is because XYZ will receive a death benefit from ABC when the client dies. XYZ must pay a death benefit to John Doe, but it has received a death benefit which can be used to offset what it must pay out.

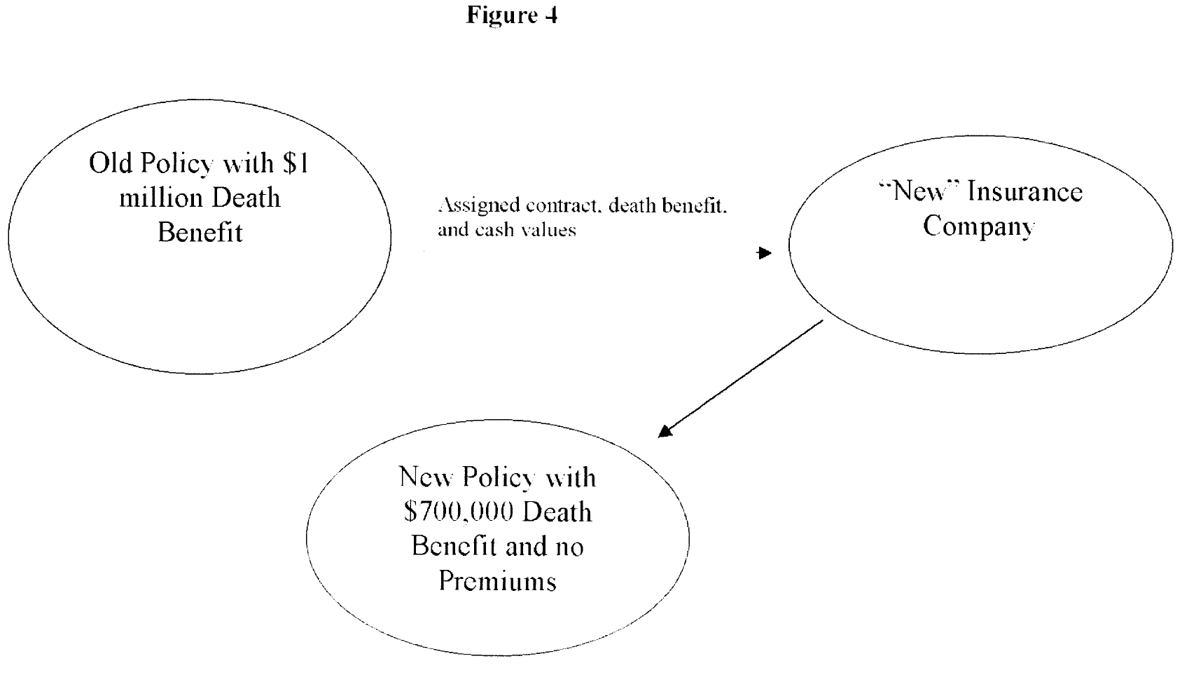

FIG. 4 shows that in some cases the death benefit could be dropped to a lower level on the new policy. John Doe comes in with a $1,000,000 policy from another insurance carrier. XYZ insurance company analyzes John Doe's health, life expectancy, and quality of existing insurance policy, and offers the owner of John Doe's life insurance a policy for $700,000 on the life of John Doe. The owner of the policy is guaranteed that there will be no further premiums. XYZ insurance company profits by receiving $1,000,000 death benefit and only having to pay out $700,000 to John Doe's beneficiaries. The policy owner is happy because there are no further premiums to be paid. XYZ's profitability is based upon their actuarial calculation of John Doe's AHLQC and that XYZ will receive $300,000 when John Doe dies. XYZ Life Insurance Company will lose money if John Doe lives too long as it will either have to continue paying much higher premiums on his old policy or it will have to take on the risk of his new policy if it surrenders his old policy. The amount of insurance XYZ agrees to issue will be based on the present value of the death benefit where present value rate equals ROI expectation. This present value will be adjusted downward by an amount equal to the present value of the costs to maintain the ABC policy. The time horizon and costs are determined using AHLQC factors.

In the above example, the new insurance policy was issued at a lower face amount than the old life insurance policy. The face amount of the new life insurance policy could also be larger than the old policy. In this scenario, a client may want $1.5 million of insurance. Client currently has $1 million policy. XYZ issues one policy with two components: $1 million issued using current invention and $500,000 issued like a normal policy. The blending of the two premiums would most likely provide the client a lower premium than buying a policy under current/conventional strategies (i.e. new carrier surrenders ABC policy and applies that money to the costs for new policy).

The present invention, in its various embodiments, is intended to work successfully with all types of existing and future life insurance plans.

While all embodiments of the present invention employ AHLQC factors to either underwrite new insurance or determine what percentage of life insurance benefits can be kept by the policy owner of the old life insurance policy, there are many options for the method of the system that underwrites new insurance or partners the old policy owner with investor's, insurance companies, partnerships, mutual funds, etc.

Money could be invested by ordinary investors in a common pool (i.e., mutual fund, general or limited partnerships, corporations, trusts, etc.). Banks, insurance companies, institutional investments, etc. could also provide the investment money. Essentially, the investment fund could buy parts of existing life insurance policies. The investors would agree to keep existing coverage in place by paying premiums. They in turn would own (and be beneficiary) for a percentage of the old life insurance policy. They would agree to pay some or all of the future premiums and in turn would receive part of the death benefit when the insured died. They would use AHLQC factors to determine what percentage of the existing life insurance that they had to keep in order to be profitable.

Possibly, a form of partnership would be used to raise the money. The partnership could be part owner (and beneficiary) of the existing life insurance. Because of the partnership, it is probable that Transfer for Value rules would be avoided. By avoiding Transfer for Value rules, there is a small possibility that the investors would receive an income tax free return on investment because of the tax treatment of life insurance, as aforementioned.

In general, according to conventional authorities, any transfer for a valuable consideration of a right to receive all or part of the proceeds of a life insurance policy is a transfer for value. The transfer for value rule extends far beyond outright sales of policies. The naming of a beneficiary in exchange for any kind of valuable consideration would constitute a transfer for value of an interest in the policy. Even the creation by separate contract of a right to receive all or a portion of the proceeds would constitute a transfer for value. On the other hand, a mere pledging or assignment of a policy as collateral security is not a “transfer for value”. . . . And a transfer will be considered a “transfer for value” even though no purchase price is paid for the policy or interest in the policy, provided the transferor receives some other valuable consideration.

Exceptions to, and exemptions from, the transfer for value rule exist when, per conventional texts: 1) Sale or transfer to insured himself 2) Sale or transfer to a partner of the insured. Sale or transfer to Corporation the insured is a shareholder or officer. Sale or transfer to members of LLC who are taxed as a partnership.

3) If the basis for determining gain or loss in the hands of the transferee is determined in whole or in part by the reference to the basis of the transferor; for example, where a policy is transferred from one corporation to another in a tax free reorganization, where the policy is transferred between spouses or where the policy is acquired by gift.

A second partnership option would be where a company or partnership (not necessarily an insurer it could be any type of business) and an insured or owner of a policy partnered. The business would essentially offer the owner of the policy a lower premium based on AHLQC factors. The company would calculate a premium that the owner of the insurance policy would have to pay probably to the insurance contract possibly to the business. A premium would be added for profitability to the business entity. If the policy owner paid the premium, the business would guarantee that the insurance coverage would stay in force. Likewise this concept could be used whereby the business could share in the death benefit and receive part of the death benefit. The business would then pay premiums. This demonstrates that this concept might not necessarily require an insurance company's participation. In summary, the client could partner with someone (or some entity) who would use AHLQC factors to determine the optimum premium for the existing contract; then, for a premium, guarantee that existing policy.

There are some potential situations where a non-profit life insurance carrier would be created to run this concept. In addition to all of the normal forms of insurance carriers there is a possibility that a Fraternal Insurance carrier could be used. Members of these fraternal organizations came together seeking mutual aid. They helped each other and, in doing so, helped themselves. Depending on a fraternal's background, known as a “common bond”, these organizations focused on social opportunities, preservation of the values of the members' homeland, cultural assimilation into the new world and assistance in everything from tuberculosis treatments to finding a wife.

Another benefit of some fraternal organizations was the provision of financial support to a surviving spouse upon the death of the member. This so called “death benefit” usually was paid to the widow after “passing the hat” at a meeting.

These fraternal organizations presumably would be operated for the benefit of the members and not require as much operating income (ie. Profit). In addition, there could be substantial tax benefits of organizing under the fraternal organization structure to provide the benefits described in this patent.

In order to achieve the objectives of rating by AHLQC factors in a way to help consumers keep existing life Insurance, a series of 1035 exchange transaction might be used. If allowed by the tax code, perhaps the 1035 exchange would be to a third party not even to an insurance company as is usually the case with 1035 exchanges. This third party might be an individual, business, pool of investments, etc. Money could flow back and forth between the third party and the insurance co., bank, investors, etc. that would guarantee the new life insurance benefit to the policy owner that signed over interests in a life insurance policy.

As mentioned in the previous paragraph, a series of policy assignments could also achieve the above objectives.

For the purpose of the present invention, 1035 exchanges and assignments are very similar. A 1035 exchange is really an assignment. In many of the scenarios in this business plan essentially a 1035 exchange is done, however, the money is not actually rolled over. In that context, it is more like an assignment. In general, the typical business practice is for insurance companies to underwrite a client's health and determine how much premium needs to be paid (the worse a client's health, the higher the premium). Once this cost for insurance is calculated, ownership of the “old” policy is transferred to the “new” carrier through an absolute assignment. It is our understanding that current practice is for the “new” carrier to surrender the “old” policy and apply those values to the new policy as pre-paid premium which can reduce the client's premium outlay. This differs from our idea in that we use AHLQC instead of just health to determine client outlay: so the worse a client's health, the better the existing contract, etc., the lower the required premium.

As mentioned in the previous paragraphs, a series of ownership and beneficiary changes could also achieve the above objectives.

Policies that were evaluated and purchased or partially purchased based on AHLQC factors could be traded as mutual fund shares or units of partnerships or other forms of businesses or Trusts. In such a manner, they could actually achieve some level of liquidity.

In any of the embodiments of the present invention, everything possible would be done to optimize any old life insurance that was kept. This might include taking partial withdrawals out against the old policy and investing the proceeds. If the investors could receive a higher rate of return, this might include borrowing money from the old insurance contract, repositioning dividends, changing dividend options, etc.

The same factors could be used to buy back (or essentially partner with the owner of the disability contract) disability insurance policies that are no longer needed because of the retirement of the worker. Assuming the disability insurance contract did not have an actively at work requirement, the purchase of or partial ownership of a disability insurance policy would provide value in some cases even if the health of the worker had not deteriorated.

The same concept as mentioned in the above paragraph could occur on some types of variable annuities. Many variable annuities have a death benefit far in excess of their cash values. This is due to the declining equity markets and also some of the automatically increasing death benefit riders on variable annuities. The purchase or partial ownership of certain types of annuities would provide value if the health of the annuitant had deteriorated. There are other annuity riders that could be taken advantage of.

The present invention encompasses the embodiments described above, and moreover, any and all embodiments within the scope of the following claims.

We claim:

1. An insurance method comprising:
receiving benefits from an owner or insured's existing insurance policy;
charging an owner or insured a premium for a new insurance policy;
calculating said premium based on AHL factors with a data processing apparatus; and
transferring at least a portion of said benefits from said owner or insured's existing insurance policy to an entity.

2. The method in claim 1, further comprising calculating said premium based on QC factors.

3. The method of claim 1, wherein said entity is a beneficiary.

4. The method of claim 1, wherein said entity is a new insurance carrier.

5. The method of claim 1, wherein said premium is lowered in proportion to the lower said insured's health.

6. The method of claim 4, wherein said new insurance company reduces reserves needed for claims.

7. The method of claim 4, wherein said new insurance company does not require reinsurance.

8. The method of claim 1, wherein said owner or insured is guaranteed a certain level of income.

9. The method of claim 1, wherein said owner or insured is not taxed on distributions from said new insurance policy.

10. An insurance method, comprising:
reviewing an owner or insured's insurance policy holdings;
reapportioning said owner or insured's insurance policy holdings per AHL factors with a data processing apparatus; and
providing said owner or insured a contract so that if said owner or insured pays a newly calculated premium, then said owner or insured's contract will remain in force.

11. The insurance method of claim 10, further comprising reapportioning said owner or insured's insurance policy holdings per QC factors.

12. The insurance method of claim 10, wherein said reviewing occurs when no great life change has occurred.

13. The insurance method of claim 10, wherein said reapportioning occurs to achieve optimal insurance coverage based upon AHL factors.

14. The insurance method of claim 1, wherein a death benefit is reduced.

15. The insurance method of claim 10, wherein a death benefit is reduced.

16. The method of claim 10, further comprising sharing the benefits of said owner or insured's insurance policy in return for providing said owner or insured said guarantee.

17. An insurance method, comprising:
reviewing an insured's AHL factors with a data processing apparatus;
offering a contract to the insured which only pays out a benefit if the insured lives longer than an agreed upon period of time.
